(19) United States
(12) Patent Application Publication
(10) Pub. No.: US 2007/0044505 A1
(43) Pub. Date: Mar. 1, 2007

(54) Coolant condensing device

(75) Inventors: Martin Kaspar, Esslingen (DE); Gerrit Wolk, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO. KG, D-70469 Stuttgart (DE)

(21) Appl. No.: 10/555,885

(22) PCT Filed: May 7, 2004
(86) PCT No.: PCT/EP04/04919

§ 371 Date: Nov. 7, 2005

(30) Foreign Application Priority Data
May 7, 2003 (DE) 103 20 572.1

(51) Int. Cl. F25B 39/04; B60H 3/00

(52) U.S. Cl. 62/509; 165/42

(57) ABSTRACT

The invention relates to a coolant condensing device, in particular for a motor vehicle comprising a plurality of flow elements which are essentially parallel with respect to each other, two distribution devices and/or collectors which are fluidly connected to the corresponding terminal parts of the flow elements, at least one dividing device which separates the distribution devices and/or collectors into at least one first and one second essentially gas and liquid-tight areas, at least one collector which is essentially parallel with respect to at least one of the distribution devices and/or collectors, said collector being provided with at least two fluidic connections to different areas of the distribution devices and/or collectors, and at least one filtering device and/or drying device. Said invention is characterised in that the coolant flow direction in at least one fluidic connection is at least essentially parallel with respect to the coolant flow direction inside the collector.

The present invention relates to a coolant condensing device, in particular for motor vehicles, air conditioning systems and also those motor vehicles normally having devices which condense a coolant flowing into them and at the same time discharge heat into the air surrounding the device, in order to thereby cool the coolant.

In the prior art, such coolant condensing devices are known, which have a multiplicity of flat tubes, at the ends of which a collecting device is arranged in each case. At the same time, a further collector is sometimes arranged parallel to these collecting devices. In the prior art, it is known that the coolant is routed through the condenser essentially from the top downward. The coolant then flows into the collector, where the gas phase is separated from the liquid phase, before only liquid coolant is conducted into the subcooling zone lying bottommost on the condenser.

For specific applications, it is expedient for the flow to pass through the condenser essentially from the bottom upward, counter to the earth's gravity field, in order, for example, to avoid a heating of the subcooling zone by a heat exchanger, (for example, oil cooler) preceding the condenser in the lower region. Even in this case, the invention is to ensure a sufficient separation of the gas and the liquid phase and a delivery of purely liquid coolant into the then top subcooling zone.

The object on which the invention is based is, furthermore, to simplify the design for condensers of this type and to reduce their mass.

This is achieved, according to the invention, by means of a coolant condensing device, in particular for motor vehicles, which has a multiplicity of throughflow devices arranged essentially parallel to one another, and also two distributing and/or collecting devices which are arranged at the respective end portions of the throughflow devices in such a way that there is a flow connection between the throughflow devices and the distributing and/or collecting devices. Furthermore, the device according to the invention has at least one separating device which subdivides at least one distributing and/or collecting device into at least one first region and at least one second region in an essentially gastight and liquidtight manner. In addition, at least one collector is provided, which is arranged essentially parallel to at least one of the distributing and/or collecting devices and which has at least two fluid connections at two different regions of this distributing and/or collecting device, at least one filter device and/or one drying device being provided in the collector. In this case, in at least one of the fluid connections, the flow direction of the coolant is, at least in portions, essentially parallel to the flow direction of the coolant within the collector.

The term “throughflow device” is understood in this context to mean a device through which a liquid or gaseous medium can flow or stream. These throughflow devices are preferably flat tubes, that is to say tubes which have in cross section a long side and a side substantially shorter than this long side. Preferably, these tubes may have one or more flow ducts for the medium flowing through. The flat tubes may run rectilinearly, but may also have one or more curved portions. In addition, flat tubes may also have twisted portions, that is to say such portions in which the tube is rotated or twirled on itself.

The term “distributing and/or collecting device” is understood, within the scope of the present invention, to mean tubes into which a gaseous or liquid medium can flow and in which the latter is collected. At the same time, however, these distributing and/or collecting devices may also serve to distribute the liquid to a plurality of throughflow devices again, and therefore, in a broader sense, they are collecting and/or distributing tubes, depending on whether the liquid flowing out of the throughflow devices into the distributing and/or collecting device is collected or whether liquid flows from the distributing and/or collecting devices into the throughflow devices and is thus distributed to these.

A flow connection between the flow devices and the distribution and/or collecting devices is understood to mean that a liquid or gaseous medium can flow or stream between the throughflow devices and the distributing and/or collecting devices.

An essentially gastight and liquidtight subdivision by a separating device is understood to mean that no liquid or no gas can flow or steam past the separating device along a specific direction of the distributing and/or collecting device.

A fluid connection between the distributing and/or collecting device and the collector is understood to mean any device through which a fluid can flow, such as, for example, a tube. It would also have to be understood that a fluid connection, however, is merely an orifice through which a fluid can emerge from the collector and enter into the distributing and/or collecting device.

The flow direction of the coolant is understood to mean the direction which the coolant preferably assumes within the collector, deflections due to individual elements arranged in the collector and limited locally being ignored. The flow direction within the collector therefore runs essentially parallel to the main direction of extent of the latter. The collector may have, as compared with the distributing and/or collecting device, the same length, but also a large or small length deviating from this.

In a preferred embodiment, in at least one of the fluid connections, the flow direction of the coolant is, at least in portions, essentially opposite to the flow direction of the coolant within the collector.

In a further preferred embodiment, the collector is produced in one piece. It is also possible, however, to produce the collector from a plurality of parts which are then connected to one another positively or in a material in an integral manner. Preferably, the collector has at least one component which is designed in the form of an extruded profile. In addition, at least one tubular component of predetermined wall thickness is provided. In this case, preferably, the wall thickness may be selected such that it withstands an internal pressure occurring in the collector. The internal pressure is of variable quantity which also depends on the degree of condensation of the coolant. By virtue of this dimensioning of the wall thickness carried out according to the internal pressure, a reduction in the mass, in particular in the specific mass, of the collector and therefore of the entire device can be achieved. The term “specific mass” is understood in this context to mean the mass in relation to the performance of the collector.

The distributing and/or collecting device, too, may be produced either in one piece or in a plurality of pieces. In a preferred embodiment, the distributing and/or collecting device is a two-piece collecting tube which is composed of two half shells.

In a further preferred embodiment, there is a fixed connection between the collector and the distributing and/or collecting device. This fixed connection may be a positive, materially integral and/or nonpositive connection consisting of a group of connections which contains welded joints, adhesive bonds, rivet joints or the like.

In a further preferred embodiment, the collector has at least one, in particular, end-face cover which is connected fixedly to the collector. The term “fixedly connected” is understood in this case to mean that the cover cannot be removed essentially without destroying or damaging the collector. The cover may, for example, be screwed, adhesively bonded, soldered, riveted or suchlike to the collector.

In a further embodiment, the collector also has a cover which is removable with respect to the collector. This may be, for example, a cover which is screwed to the collector. Thus, for example, the collector may have an internal thread, into which this removable cover is screwed, or else an external thread, onto which the said cover is screwed. It is also possible, however, to design the cover in such a way that it is pushed into the collector and on its outer circumference has sealing devices, such as, for example, O-rings, sealing off the collector in a liquidtight and gastight manner. In addition, bayonet fastenings or the like may also be used.

In a further embodiment, there are two fluid connections between the distributing and/or collecting devices and the collector, one fluid connection leading into a first region of the collector, the other fluid connection leading into a second region of the collector, and the two regions being spaced apart from one another within the collector.

More precisely, one fluid connection is introduced into the collector at a point which is spaced apart from the point at which the second fluid connection is introduced into the collector. The term “spaced apart” is to be understood in this case to mean that the spacing between the two supply lines of the fluid connections into the collector are not negligible in relation to the length of the collector, for example amounts to one tenth or more of the length of the latter.

In a further embodiment, at least one fluid connection leads into an essentially end-face portion of the collector. The term “end-face portion of the collector” is understood in this case to mean a region of the collector which lies outside the middle third in the longitudinal direction of the collector.

In a further embodiment, the collector is offset laterally with respect to a plane spanned by the distributing and/or collecting devices and the throughflow devices. The throughflow devices and the distributing and/or collecting devices are arranged in such a way that the main directions of extent of the throughflow devices and the main directions of extent of distributing and/or connecting devices are essentially perpendicular to one another. The collector is offset laterally with respect to the plane spanned by these two main directions of extent.

In a further preferred embodiment, the two collecting devices have a plurality of separating devices which subdivide the distributing and/or collecting devices into a plurality of regions in an essentially gastight and liquidtight manner.

In a further preferred embodiment, the drying device and/or the filter device is removable from the collector. In this case, for example, the collecting and/or drying device may also be connected fixedly to the cover which is removable from the collector by the cover of the filter and/or drying device being removed. The filter and/or drying device may, however, also be arranged separately from the cover.

In a further preferred embodiment, the collector has a connecting device for connection to the fluid connection. This may be preferably, but not exclusively, a connecting flange or the like for the preferably tubular fluid connection.

In a further embodiment, there is between at least two device devices a connection which is selected from a group which contains welded joints, adhesive bonds, rivet joints or the like. What are understood as meaning device devices are in this case, for example, inter alia, the throughflow devices, the distributing and/or collecting devices of the collectors or else the fluid connection.

Further advantages and embodiments of the device according to the invention may be gathered from the accompanying drawings in which:

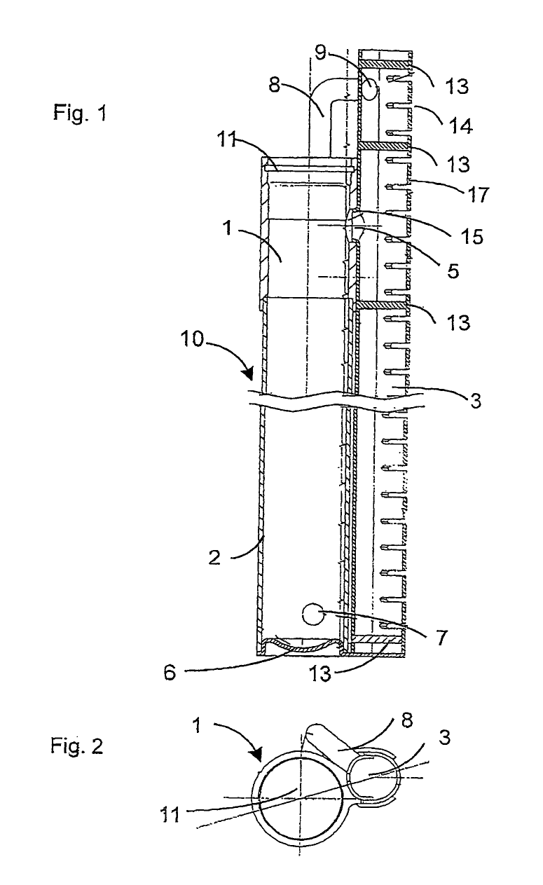

FIG. 1 shows a partial illustration of a device according to the invention for condensing a coolant,

FIG. 2 shows a top view of the illustration from FIG. 1,

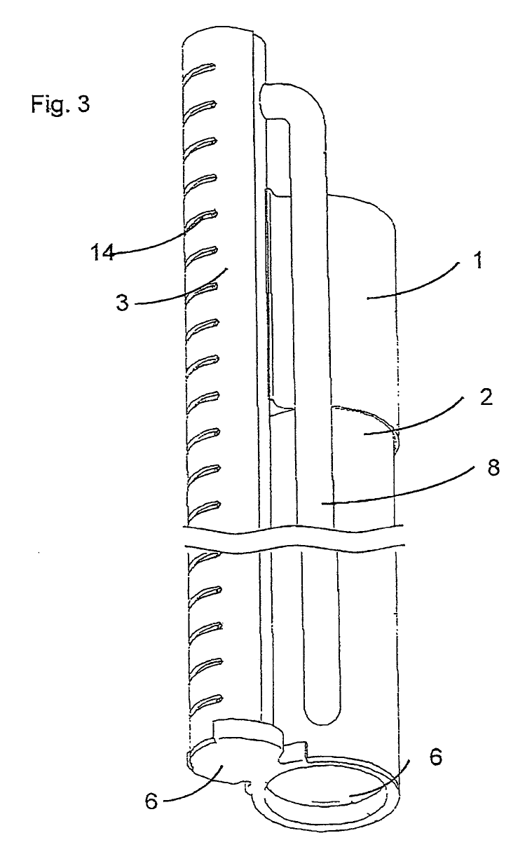

FIG. 3 shows a further view of a detail of a device according to the invention for condensing a coolant, and

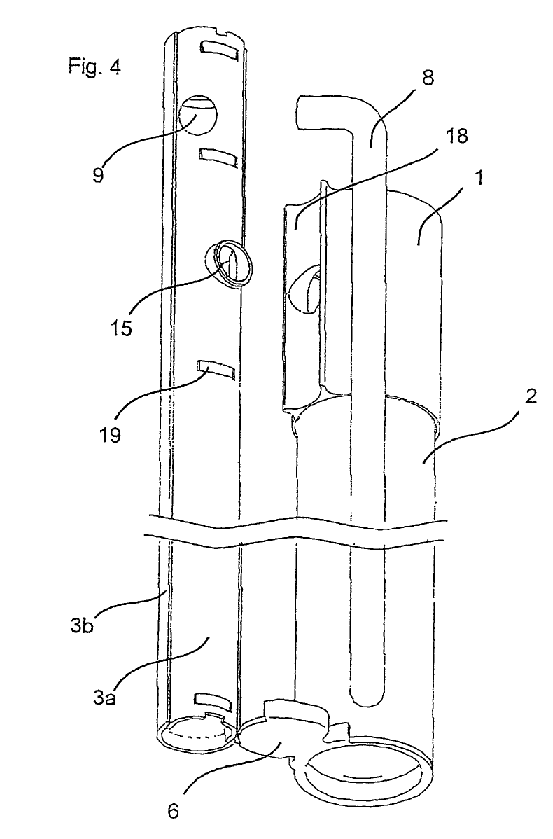

FIG. 4 shows an illustration of the view from FIG. 3 in which the individual components have been separated from one another for illustrative purposes.

FIG. 1 shows a view of a detail of a device according to the invention for condensing a coolant. In this case, the reference symbol 10 refers to a collector which consists here of two subunits 1 and 2. The first subunit 1 is, for example, a short extruded profile, and the subunit 2 is a tube, the wall of which is preferably dimensioned in its thickness such that the tube withstands the required internal pressure of the fluid. The subunit 1 has an orifice 5 through which a coolant can enter the collector. The second subunit 2 has an orifice 7 through which the coolant can preferably emerge from the collector. The coolant passes from the outlet orifice 7 into a tube 8 (FIG. 2), of which only the upper portion is illustrated here, since it is located behind the collector, and via this tube 8, via an orifice 9, into a distributing and/or collecting device which is designated as a whole by 3. This distributing and/or collecting device 3 has a plurality of partitions 13 which lie perpendicularly to the longitudinal direction I of the tube and through which the coolant cannot pass in the longitudinal direction. Furthermore, the distributing and/or collecting device has receiving devices, such as orifices 14, in order to receive throughflow devices (not shown). These throughflow devices would extend to the right from the device in the drawing.

At the second end, that is to say as seen on the right from the throughflow devices (not shown), a second distributing and/or collecting device (not shown) is arranged, which likewise has separating devices 13 and is thereby subdivided into a plurality of subspaces. During operation, a preferably gaseous coolant passes via a supply line into the lower distributing and/or collecting device (not shown) of the condenser. This supply line is preferably arranged in a, with respect to the drawing, lower region of the second distributing and/or collecting device (not shown). The coolant is conducted from there to and fro in a predetermined number of throughflow devices arranged between the two distributing and/or collecting devices, that is to say in individual part regions defined by the partitions 13, and finally passes into the subspace 17 of the distributing and/or collecting device 3, said subspace likewise being delimited by two separating devices 13. The coolant passes through this region 17 via the orifice 5 into the collector 10, more precisely the upper region of the latter. As a result of the action of gravity, the coolant flows downward within the collector and, via the orifice 7 of the collector, out of the latter.

The coolant passes from the orifice 7 via the tube 8 and the orifice 9 into the uppermost region of the distributing and/or collecting device 3, said uppermost region likewise being delimited by two separating devices 13. The coolant can pass from there via throughflow devices, that is to say flat tubes, into the second distributing and/or collecting device (not shown) again and be discharged from there out of the device.

The distributing and/or collecting device 3 may be produced in one piece or in a plurality of pieces. Preferably, but not exclusively, it may be a two-piece distributing and/or collecting device, that is to say one formed from two half shells.

Reference numeral 6 refers to a cover which closes off the collector downwardly. This cover may, for example, be pressed into the tube. However, other connections, such as welding, soldering, riveting or the like, are also possible. At its upper end, too, the collector has a cover 11 which closes the latter upwardly. This cover, too, may be connected fixedly to the collector, but this cover is preferably removable from the collector, for example via screws, threads or the like.

Instead of a cover, the collector could also have a plug. A dryer and/or a filter (not shown) is located within the collector. Preferably, after the removal of the cover 11 from the collector, this dryer can be taken out of the collector or pushed into it. However, it is also possible, after a dryer has been pushed in to weld or adhesively bond the collecting container. The length of the collector may, in principle, have any desired length, that is to say be longer or shorter than or exactly as long as the distributing and/or collecting device. FIG. 2 shows the top of the device from above. Reference symbol 3 refers to the distributing and/or collecting device, reference symbol 1 refers to the upper part of the collector and reference symbol 8 refers to the connecting tube between the collector and the distributing and/or collecting device.

In this illustration, throughflow devices would extend to the right along the line B. It can therefore be seen that the collector is offset laterally by a predetermined angle α with respect to a plane which is spanned by the distributing and/or collecting device 3 and the throughflow devices (not shown). This angle α is between 0 and 80°, preferably between 5 and 45°, and, particularly preferably, between 10 and 30°.

FIG. 3 shows a perspective illustration of a detail of the device according to the invention. Reference symbols 1 and 2 refer again to the two subunits of the collector. In the present embodiment, the subunit 1 of the collector has a supporting strip (not shown) for the distributing and/or collecting device 3. This supporting strip serves, inter alia, for the better fixing of the distributing and/or collecting device with respect to the collector, particularly during the soldering process. Reference symbol 14 refers again to the rim holes for the throughflow devices (not shown). Reference symbol 6 identifies the cover which closes off the collector downwardly. This cover has a lateral prolongation in the direction of the distributing and/or collecting device, said prolongation being held by means of a suitable shape-out portion of the distributing and/or collecting device and positioning the two parts in relation to one another. Preferably, but not exclusively, this cover is a double cover 6 which seals off downwardly both the collector and the distributing and/or collecting device. It is also possible, however, to provide for the distributing and/or collecting device 3 and for the collector different covers which are subsequently welded, soldered or otherwise connected to one another.

Reference symbol 8 again refers to a tube through which the coolant is conducted from the collector back into the distributing and/or collecting device 3. Within the tube, as stated, the coolant passes via the orifice 9 into the distributing and/or collecting device again. This orifice may be designed as a connection piece, for example for better tube soldering.

However, instead of being introduced laterally via an orifice 9 into the distributing and/or collecting device, the tube could also be introduced into the latter from above on the end face. In this case, the uppermost separating device 13 in FIG. 1 could be dispensed with.

The lower orifice 7 of the collector could also be integrated into the cover of the latter on the end face. Preferably, the orifice 7 is arranged as low as possible within the collector, so that, as far as possible, the entire coolant can be discharged from the collector.

The coolant travels from the top downward within the collector under the action of gravity. In this case, separation also occurs between the liquid and the gaseous phase of the coolant. This separation may be further assisted by the coolant being routed onto a predetermined path within the collector.

The tube 8 may be integrated and cosoldered in the collector and the distributing and/or connecting device before the soldering process in the soldering furnace, but it may also be, for example, flame-soldered by hand at a later stage after the soldering process.

The collector too, may be mounted by hand soldering on the distributing and/or collecting device after the operation of soldering the remaining condenser block, that is to say the distributing and/or collecting devices and the throughflow devices.

FIG. 4 shows a view of the detail from FIG. 3, but the individual components, that is to say the throughflow device 3, the collector 2 and the tube, have been separated from one another for the sake of greater clarity. It can be seen that, in the present embodiment, the subunit 1 of the collector has a guide device 18, into which the collector 3 can be inserted, the collector and the distributing and/or collecting device being connectable to one another via the connecting devices 19. Reference symbol 15 refers to a connection piece which is mounted on the distributing and/or collecting device and which can be inserted into the inlet orifice 5 of the region 1 of the collector and can be connected to the latter for fixing.

It can be seen that, in the present case, the distributing and collecting device 3 is formed from two half shells 3a and 3b which, for example, may be soldered, adhesively bonded, welded or suchlike to one another.

It can likewise be seen that the cover, which forms the lower termination of the collector and the distributing and/or collecting device, is profiled in such a way that it is suitable for receiving the distributing and/or collecting device 3. The drying and filter device (not shown) within the collector may be designed in such a way that the coolant has to pass completely through the filter and cannot flow past the latter. This may be achieved preferably, but not exclusively, via sealing rings, beads on the inner circumference of the collector or the like.

The drying device may be, for example, a cartridge which is introduced into the collector and within which a drying agent is arranged. The drying device may, however, also be a small bag filled with drying agent.

As already stated, instead of the two-part collector consisting of the subunits 1 and 2, a fully extruded tube or else a fully welded tube may also be used.

1. A coolant condensing device, in particular for motor vehicles, with a multiplicity of throughflow devices arranged essentially parallel to one another, with two distributing and/or collecting devices which are fluid-connected at the respective end portions of the throughflow devices, with at least one separating device which subdivides the distributing and/or collecting devices into at least one first region and at least one second region in an essentially gastight and liquidtight manner, and with at least one collector which is arranged essentially parallel to at least one of the distributing and/or collecting devices and has at least two fluid connections at two different regions of this distributing and/or collecting device and in which at least one filter device and/or one drying device is provided, wherein, in at least one of the fluid connections, the flow direction of the coolant is, at least in portions, essentially parallel to the flow direction of the coolant within the collector.

2. The device as claimed in claim 1, wherein, in one of the fluid connections, the flow direction of the coolant is, at least in portions, essentially opposite to the flow direction of the coolant within the collector.

3. The device particularly as claimed in claim 1, wherein the collector is produced in one piece.

4. The device particularly as claimed in claim 1, wherein the collector consists of a plurality of parts.

5. The device particularly as claimed in claim 1, wherein the collector has at least one component which is designed in the form of an extruded profile.

6. The device particularly as claimed in claim 1, wherein the collector has at least one tubular component of predetermined wall thickness.

7. The device particularly as claimed in claim 1, wherein there is a fixed, in particular positive or materially integral connection between the collector and the distributing and/or collecting device.

8. The device particularly as claimed in claim 1, wherein the collector has at least one cover which is connected to the collector materially integrally, positively and/or nonpositively.

9. The device particularly as claimed in claim 1, wherein the collector has at least one cover which is removable with respect to the collector.

10. The device particularly as claimed in claim 1, wherein two fluid connections are provided between the distributing and/or collecting device and the collector, one fluid connection leading into a first region of the collector, the other fluid connection leading into another region of the collector and the two regions being spaced apart from one another.

11. The device as claimed in claim 1, wherein at least one fluid connection leads into an essentially end-face portion of the collector.

12. The device as claimed in claim 1, wherein the collector is offset laterally with respect to a plane spanned by the distributing and/or collecting devices and the throughflow devices.

13. The device particularly as claimed in claim 1, wherein the distributing and/or collecting devices have a plurality of separating devices which subdivide the distributing and/or collecting devices into a plurality of regions in essentially a liquidtight manner.

14. The device particularly as claimed in claim 1, wherein the drying device and/or the filter device is removable from the collector.

15. The device particularly as claimed in claim 1, wherein the collector has a connecting device for connection to the fluid connection.

16. The device particularly as claimed in claim 1, wherein, between at least two device devices, there is a connection which is selected from a group which contains welded joints, adhesive bonds, rivet joints or the like.
